(19) United States
(12) Patent Application Publication
(10) Pub. No.: US 2025/0004115 A1
(43) Pub. Date: Jan. 2, 2025

(54) CORRECTION OF ULTRASOUND-BASED MEASUREMENTS BY MEANS OF ANGLE INFORMATION

(71) Applicant: Robert Bosch GmbH, Stuttgart (DE)

(72) Inventors: Matthias Boecker, Saarbrücken (DE); Michael Schumann, Stuttgart (DE)

(21) Appl. No.: 18/709,648

(22) PCT Filed: Nov. 11, 2022
(86) PCT No.: PCT/EP2022/081593

§ 371 Date: May 13, 2024

(30) Foreign Application Priority Data
Nov. 19, 2021 (DE) 10 2021 213 034.8

(51) Int. Cl. G01S 7/52; G01S 15/87; G01S 15/931

(52) U.S. Cl. CPC G01S 7/52004; G01S 15/872; G01S 15/876; G01S 15/931; G01S 2015/939

(57) ABSTRACT

A method for correcting at least one ultrasound-based measurement of an ultrasonic sensor of a sensor arrangement using a control device. At least one ultrasonic sensor transmits and/or receives sound waves, wherein, based on a time-of-flight measurement of the sound waves, at least one distance to a reflection position along a measurement plane is determined, at least one angle within the measurement plane and/or outside the measurement plane is determined by evaluation of measurement data from transducer elements of at least one ultrasonic sensor array, and a localization error of the at least one determined distance between the ultrasonic sensor and the reflection position is corrected using the determined angle. A sensor arrangement, a control device, a computer program, and a machine-readable storage medium are also described.

### FIELD

The present invention relates to a method for correcting at least one ultrasound-based measurement, a sensor arrangement, a control device, a computer program, and a machine-readable storage medium.

### BACKGROUND INFORMATION

Ultrasonic sensors in park assists are used to detect parking spaces and obstacles. To do this, sound waves are generated, reflected by obstacles and then received. The time-of-flight of the sound waves enables the distance between the ultrasonic sensor and the obstacle to be calculated. In addition, a trilateration of measurement results from a plurality of ultrasonic sensors can be carried out within a measuring plane parallel to the ground in order to localize the obstacle. Due to the position of the ultrasonic sensors along the measuring plane, it is assumed that all reflection points on an obstacle are also at the height of the measuring plane. Deviations from this assumption result in localization errors.

However, due to the characteristics of ultrasonic sensors, reflection points are located along an ellipse or a circle, which means that reflection points are also detected outside the measuring plane. In particular, distances from low reflex points such as curbs, or high reflex points such as barriers, cannot be determined with sufficient precision on the basis of ultrasound. Such deviations from the assumption can also result in distorted object positions and incorrectly classified objects.

European Patent Application No. EP 2 113 436 A1 describes the use of a special height sensor in conjunction with ultrasonic sensors for distance measurement. Great Britain Patent Application No. GB 2486452 A describes a method for determining the wading depth of a vehicle in water, in which an ultrasonic sensor is pivoted or mounted facing the ground in order to determine height information.

### SUMMARY

An object of the present invention can be considered that of providing a method and a sensor arrangement which avoid incorrect object formation as a result of misclassification or due to ambiguities and improve ultrasound-based distance measurement.

This object may be achieved by features of the present invention. Advantageous embodiments of the present invention are disclosed herein.

According to one aspect of the present invention, a method for correcting at least one ultrasound-based measurement of an ultrasonic sensor of a sensor arrangement is provided. The method can preferably be executed by a control device.

According to an example embodiment of the present invention, in one step, sound waves are transmitted and/or received by at least one ultrasonic sensor. On the basis of a time-of-flight measurement of the sound waves, at least one distance to a reflection position along a measuring plane is determined. Reflection positions determined in this way are created under the assumption that all obstacles or objects that cause the sound waves to be reflected are arranged along the measurement plane.

Due to the radiation characteristics, the reflection positions can be arranged along a curve above or below the measuring plane so that the actual distance along the measuring plane is smaller. This deviation in the distance between the real reflection position and its projection onto the measurement plane is defined below as a localization error.

This knowledge is used to determine at least one angle within the measuring plane and/or outside the measuring plane by evaluating measurement data from transducer elements of at least one ultrasonic sensor array. The localization error of the at least one determined distance between the ultrasonic sensor and the reflection position is then corrected by the determined angle.

In particular, the Pythagorean theorem or trigonometric functions can be used to correct the localization error and determine the distance along the measuring plane in the form of a projection of the reflection position.

By means of the method of the present invention, the ultrasound-based localization of objects can be improved, and incorrect object formation and the resulting misclassification can be avoided.

Furthermore, the use of angle information or determined angles to reflection positions can achieve greater flexibility when installing the ultrasonic sensors in the vehicle since the height offset limitation for the installation position of the ultrasonic sensors is eliminated by compensating for the height differences in ultrasound-based measurement.

According to a further aspect of the present invention, a control device is provided, wherein the control device is configured to carry out the method of the present invention. The control device can be, for example, an on-board control device, an off-board control device, or an off-board server unit such as a cloud system.

According to an example embodiment of the present invention, the control device can preferably be connected to at least one ultrasonic sensor and to at least two transducer elements of at least one ultrasonic sensor array in a data-conducting manner. In particular, the control device can be used to individually control the transducer elements for transmitting and/or receiving sound waves.

Furthermore, according to one aspect of the present invention, a computer program is provided which comprises commands which, when the computer program is executed by a computer or a control device, cause this to carry out the method according to the present invention. According to a further aspect of the present invention, a machine-readable storage medium is provided, on which the computer program according to the present invention is stored.

In this case, according to the BASt standard, the vehicle can be operated in an assisted, partially automated, highly automated and/or fully automated or driverless manner.

The method is not limited to all sensors in the sensor arrangement having a height measurement capability. For example, only two sensors can also be designed as ultrasonic sensor arrays, which are then positioned between the “single-element transducers” or bulk ultrasonic sensors. Preferably, at least one measured object is “seen” or registered by at least one sensor of the sensor arrangement over a certain time range. Historical angle information can then also be used for the correction. The performance of the sensor arrangement can be improved by adding further ultrasonic sensors and/or ultrasonic sensor arrays.

In one exemplary embodiment of the present invention, an azimuth angle within the measuring plane and/or an elevation angle outside the measuring plane is determined as at least one angle by the ultrasonic sensor array. This measure allows the determined angle information to be three-dimensional so that an angle restriction along the measuring plane to avoid ambiguities and an angle component along the height direction to correct localization errors are possible at the same time.

According to a further embodiment of the present invention, at least two distances are determined by at least two ultrasonic sensors and/or by an ultrasonic sensor and at least one ultrasonic sensor array along a measuring plane on the basis of a time-of-flight measurement of sound waves.

A localization of reflection positions is carried out by means of trilateration, wherein the localization error of the at least one determined distance between an ultrasonic sensor and a reflection position before trilateration or after trilateration is corrected by the determined angle. This allows the correction of the localization error to be implemented in advance in the area of the raw distances or echo lengths. Alternatively, a subsequent correction of one or more localization errors can be carried out after trilateration.

According to a further exemplary embodiment of the present invention, a check is carried out as to whether at least two distances determined within the measuring plane were determined by reflection on a common object or on a plurality of different objects. This measure allows a plurality of distances or echo lengths to be assigned to one or more objects or “paired” with each other. This also allows the echo lengths relevant for trilateration to be selected.

According to a further embodiment of the present invention, the localization error of the at least one determined distance is corrected by the determined angle to a predefined height of the measuring plane above the ground. This makes it possible to correct the localization errors by projecting a distance between an ultrasonic sensor and the reflection position onto the measuring plane in order to obtain an exact distance to the vehicle or sensor arrangement.

According to a further exemplary embodiment of the present invention, the localization error of the at least one determined distance is corrected by the determined angle to a height corresponding to a lowest installation position of an ultrasonic sensor of the sensor arrangement above the ground. This measure allows the measurements of ultrasonic sensors arranged at different heights to be aligned with a lowest ultrasonic sensor and compensated with regard to deviations in distances using the determined angles.

According to a further embodiment of the present invention, at least one reflection position determined by trilateration and/or at least one reflection position determined by individual measurements are assigned to at least one existing or one new object. This allows existing objects to be extended by new reflection positions, or new objects to be registered with the help of the determined reflective positions.

According to a further exemplary embodiment of the present invention, the angle determined as the azimuth angle within the measuring plane is used to resolve at least one ambiguity in the assignment of reflection positions to objects. The determined azimuth angle, which can preferably be configured as an angular range, can be used to restrict possible angular ranges. Such a restrictions prevents further consideration of reflection positions outside the angular range and can prevent ambiguities in ultrasound-based object detection.

According to a further aspect of the present invention, a sensor arrangement is provided for carrying out the method according to the present invention. The sensor arrangement has a control device, at least one ultrasonic sensor and at least one ultrasonic sensor array.

The at least one ultrasonic sensor and the at least one ultrasonic sensor array have the same and/or a different installation height on a contour, in particular a vehicle contour.

According to an example embodiment of the present invention, the ultrasonic sensor array of the sensor arrangement has at least two transducer elements spaced apart in the vertical direction and/or in the horizontal direction, wherein the transducer elements and the at least one ultrasonic sensor can be actuated and/or read out by a control device electrically connected to the transducer elements.

According to an example embodiment of the present invention, the particular transducer elements are designed as partial sensors of the ultrasonic sensor array and can be controlled and evaluated independently of each other by the control device. In particular, the generated sound waves of the transducer elements can interfere with each other, which causes the main axis of the emitted sound echoes to be tilted or deflected relative to the surface normal.

In particular, the main axis of the vertical sound radiation can be tilted relative to the main axis of the sensor membrane by actuating the transducer elements out of phase, for example between vertically offset rows of elements.

Preferably, the transducer elements, which are excited by membrane vibrations and/or cylinder vibrations to generate and receive sound waves, are arranged on a common plane with which the surface normal is defined.

According to an example embodiment of the present invention, the at least one ultrasonic sensor array can preferably be manufactured using MEMS technology and designed, for example, as a so-called piezoelectric micromachined ultrasonic transducer (PMUT sensor). The transducer elements can be designed as membranes or as vibrating pistons or as combined membrane-piston arrangements in order to generate and/or receive sound pulses or sound waves.

The control device can determine an angle relative to a surface normal of the ultrasonic sensor array according to the determination of a phase shift between the electrical signals of the respective transducer elements. This measure allows the ultrasonic sensor array to be dynamically adapted to reflection positions with different heights in relation to the ground. A determined phase shift is directly dependent on the angle at which the sound waves from the reflection position are received by the transducer elements.

According to a further aspect of the present invention, a method for resolving ambiguities of at least one ultrasound-based measurement of a sensor arrangement is provided. This method can also be carried out by the control device.

According to an example embodiment of the present invention, in one step, sound waves are transmitted and/or received by at least one ultrasonic sensor and by at least one ultrasonic sensor array. On the basis of a time-of-flight measurement of the sound waves, at least two distances to different reflection positions are determined.

At least one angle between the ultrasonic sensor array and at least one reflection position is determined by evaluating measurement data from transducer elements of the ultrasonic sensor array.

The at least one determined angle is then used to assign reflection positions and/or determined distances to at least one object. In particular, this can limit the possible detection range of ultrasonic sensors and avoid the presence of ambiguities in the detection of objects.

Preferred exemplary embodiments of the present invention are explained in more detail below with reference to highly simplified schematic representations.

### BRIEF DESCRIPTION OF THE DRAWINGS

FIG. 1 shows a perspective view of an ultrasonic sensor array of a sensor arrangement according to one example embodiment of the present invention.

FIGS. 2 and 3 show side views of a sensor arrangement installed in the vehicle to illustrate a localization error, according to an example embodiment of the present invention.

FIG. 4 shows a flowchart for illustrating a method according to one example embodiment of the present invention.

FIGS. 5 and 6 show schematic plan views of a sensor arrangement for illustrating and resolving ambiguities, according to an example embodiment of the present invention.

### DETAILED DESCRIPTION OF EXAMPLE EMBODIMENTS

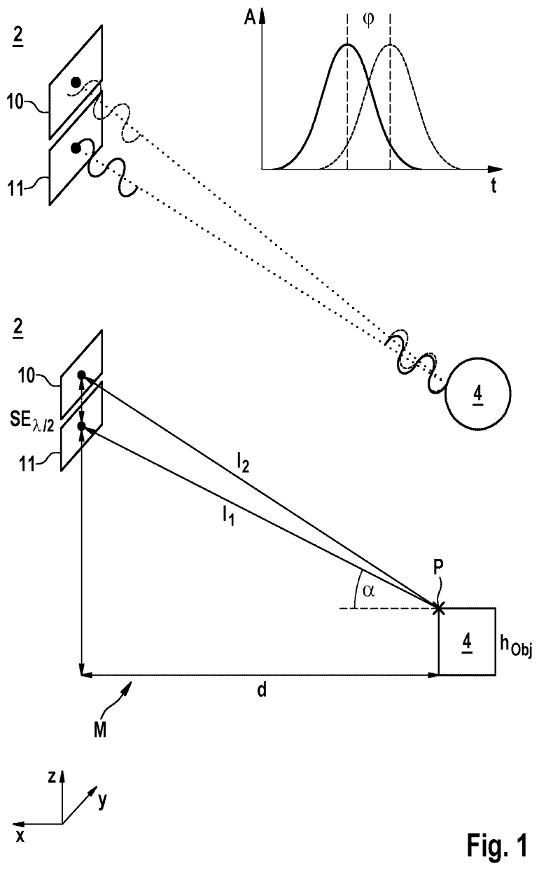

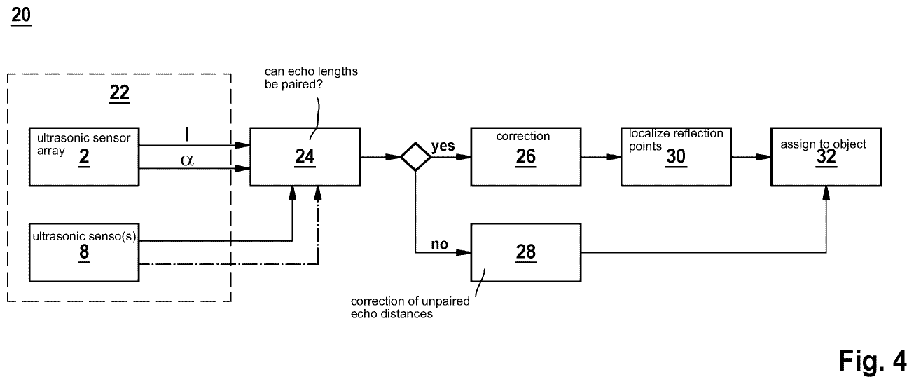

FIG. 1 shows a perspective view of an ultrasonic sensor array 2 of a sensor arrangement 1 according to one embodiment. The sensor arrangement 1 is used to perform a method 20 which is described in more detail in FIG. 4.

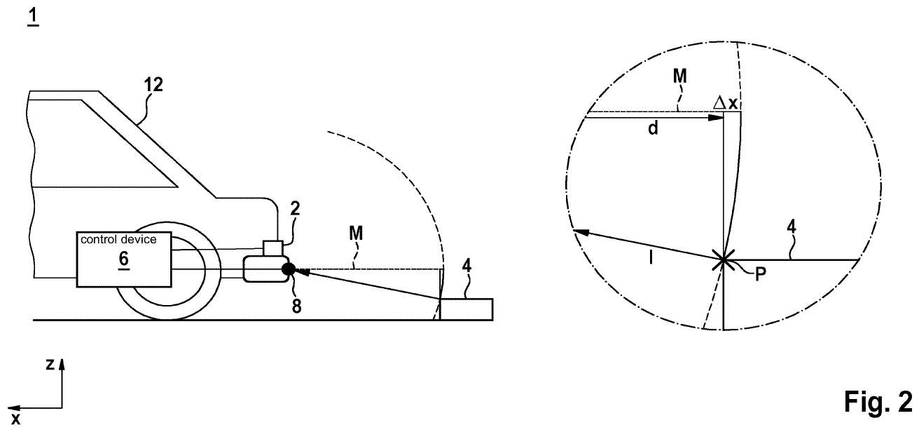

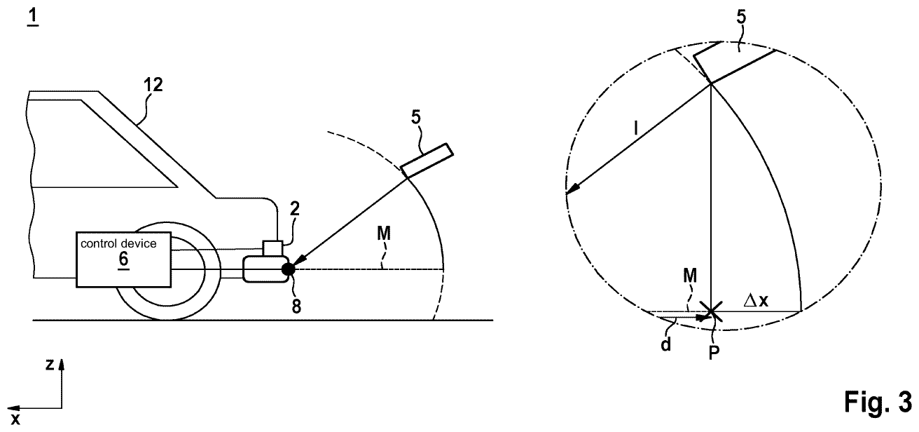

In particular, the sensor arrangement 1 is described in detail in FIG. 2 and FIG. 3. The sensor arrangement 1 has a control device 6, at least one ultrasonic sensor 8 and at least one ultrasonic sensor array 2. The functional principle of the ultrasonic sensor array 2, which for example comprises two transducer elements 10, 11 is described here.

The ultrasonic sensor array 2 of the sensor arrangement 1 has at least two transducer elements 10, 11 spaced apart in the vertical direction z and/or in the transverse direction y, wherein the transducer elements 10, 11 and the at least one ultrasonic sensor 8 can be actuated and/or read out by a control device 6 electrically connected to the transducer elements 10, 11.

FIG. 1 explains the basic principle of the ultrasonic sensor array 2 with height measurement capability. This describes the time-of-flight measurement of reflected sound waves at an angle of incidence α.

The backscattering or reflection at the object 4 is still in phase, and the backscattering is uniform in similar directions. When the reflected sound waves hit the two transducer elements 10, 11, a phase difference φ can arise depending on the relative position of the low object 4 to the corresponding transducer element 10, 11. This results from the different paths 11, 12 that the particular sound waves travel to the offset transducer elements 10, 11.

However, a distance d between the ultrasonic sensor array 2 and the object 4 along a measuring plane M remains the same and corresponds to a projection. In the shown exemplary embodiment, the low object 4 corresponds to a curb which is lower than the sensor arrangement 1 or the ultrasonic sensor array 2.

For example, the measuring plane M is arranged parallel to the x-y plane which is defined by the direction of travel x and a transverse direction y.

The phase difference or phase shift φ of electrical signals that are generated from the received sound waves by the transducer elements 10, 11 can be determined by the control device 6. The phase shift φ is proportional to the angle or elevation angle α which is spanned along the height direction z.

The transducer elements 10, 11 are spaced apart at a distance of λ/2 along the height direction z.

FIG. 2 and FIG. 3 show side views of a sensor arrangement 1 installed in the vehicle to illustrate a localization error Δx. In particular, the localization error Δx due to a low object 4 or obstacle is illustrated in FIG. 2, and the localization error Δx due to a high object 5 or high obstacle is illustrated in FIG. 3.

The at least one ultrasonic sensor 8 and the at least one ultrasonic sensor array 2 have the same and/or a different installation height on a contour of a vehicle 12.

Due to the deviation of the position of the objects 4, 5 from the measuring plane M, the projection of the direct distance l to the object 4, 5 has a localization error Δx. The direct distance l between the object 4, 5 and the ultrasonic sensor 8 corresponds to the sum of the localization error Δx and the projected distance d between the ultrasonic sensor 8 and the object 4, 5 along the measuring plane M. As a result, the object 4, 5 is registered by the sensor as being further than it actually is.

In particular after a start or a reset of the vehicle 12, the corresponding distances, for which the projected distance d is assumed to correspond to the direct distance l, are available in an uncorrected form.

However, if an elevation angle α is given, the measured echo lengths l can be corrected to a previously defined measuring plane M using the Pythagorean theorem.

Alternatively, trilateration can be carried out first and then a correction to the projection of the echo length l onto this measuring plane M.

FIG. 4 shows a schematic flowchart for illustrating a method 20 according to one embodiment. The method 20 is used to correct at least one ultrasound-based measurement of an ultrasound sensor 8 of a sensor arrangement 1.

In a step 22, sound waves are transmitted and/or received by at least one ultrasonic sensor 8. On the basis of a time-of-flight measurement of the sound waves, at least one distance l to a reflection position along a measuring plane is determined.

Due to the radiation characteristics, the reflection positions P can be arranged along a curve above or below the measuring plane M (see FIG. 2 and FIG. 3), so that the actual or projected distance d along the measuring plane M is smaller. At the same time, height information or an elevation angle α is determined by evaluating measurement data from the ultrasonic sensor array 2.

In a further step 24, a check is carried out to determine whether the echo lengths l of the different sensors 2, 8 can be paired.

In addition to the criteria such as intersection point formation and the match of other echo attributes, the elevation angle α and, if available, an azimuth angle β can be included as an additional attribute in the check.

The localization error Δx of the at least one determined distance l between the ultrasonic sensor 8 and a reflection position R (see FIG. 1) is then corrected by the determined angle α, β.

A correction 26 is made to the determined distances or echo distances 1, if echoes can be paired, in relation to a predefined system height or height of the measuring plane M. For example, the measuring plane M can have a height that corresponds to the lowest installation position of an ultrasonic sensor 8 of the sensor arrangement 1 in the vehicle 12.

Alternatively or additionally, the correction 28 of unpaired echo distances 1 is performed individually with a different elevation angle α.

In a further step 30, reflection positions P are localized by means of trilateration.

Subsequently, at least one reflection position P determined by trilateration and/or at least one reflection position P determined by individual measurements are assigned to at least one existing or one new object 32. This can be done by comparing a database of objects that have already been created.

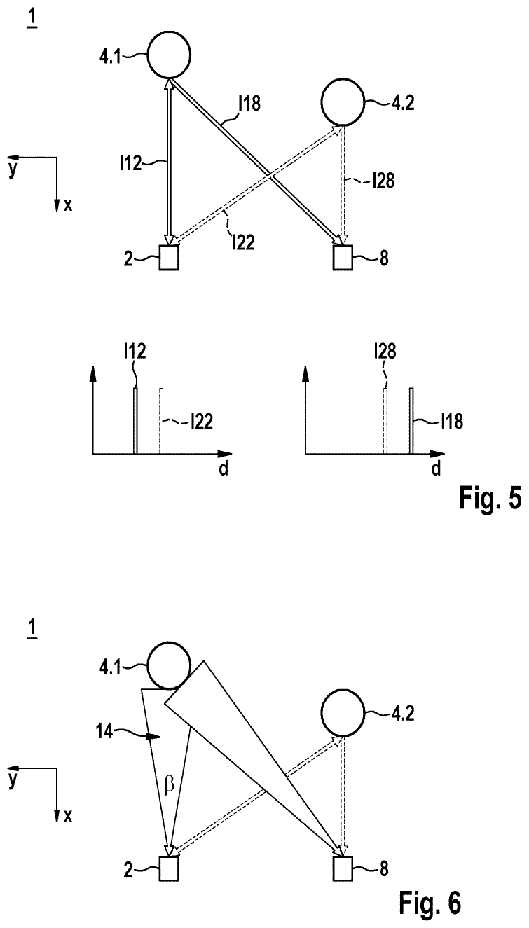

FIG. 5 and FIG. 6 show schematic top views of a sensor arrangement 1 to illustrate and resolve ambiguities. Echo distances 112, 122, 128, 118 are shown schematically for scenes with several objects 4.1, 4.2 in the event that only the ultrasonic sensor array 2 transmits and receives, and the ultrasonic sensor 8 only receives.

The setup results in the shown paths or echo distances 112, 122, 128, 118 so that the ultrasonic sensor array 2 first receives the echo 112 from object 4.1 and then the echo 122 from object 4.2. Precisely the opposite is true for the receiving ultrasonic sensor 8. This first receives the echo 128 which was reflected by the second object 4.2, and then the echo 118 which was reflected by the first object 4.1.

Due to the large sensor distances compared to the wavelength, ambiguities occur in the presence of several objects 4.1, 4.2. To determine the position, the echo distances 112, 122, 128, 118 of the sensors 2, 8 must be trilaterated. From the illustration, it can be recognized that there are now two possibilities:
112 with 128 and 122 with 118, or
111 with 128 and 112 with 118.

Without prior knowledge such as during a startup or reset of the vehicle 12 or the sensor arrangement 1, it is impossible to decide which of the two options is the correct pairing. For this purpose, FIG. 6 uses the option of determining an azimuth angle β by means of the ultrasonic sensor array 2.

By adding one or more sensors 2 with a determined azimuth angle β, an object position estimate can be carried out. If the trilaterated object position P is within the estimated range 14, then a correct echo pairing can be assumed.

The proposed method is also helpful if the azimuth aperture or the estimated range 14 is chosen to be larger since the trilateration yields an improvement of the position determination in any case.

By determining the azimuth angle β in addition to the echo distance, the permitted angular range 14 for the object position can now be determined. The ambiguities can be resolved if at least one of the two sensors 2, 8 can provide measurement data to determine an azimuth angle β. Alternatively or additionally, both sensors or all sensors of the sensor arrangement 1 can be designed as ultrasonic sensor arrays 2 and therefore provide information on the azimuth angle β.

This azimuth angle β can already be used in method step 24, the formation of pairs, in addition to the other attribute checks already mentioned in order to perform a check of the azimuth angle β.

1-13. (canceled)

14. A method for correcting at least one ultrasound-based measurement of an ultrasonic sensor of a sensor arrangement by a control device, the method comprising the following steps:
transmitting and/or receiving sound waves by at least one ultrasonic sensor, and determining at least one distance to a reflection position along a measuring plane based on a time-of-flight measurement of the sound waves;
determining at least one angle within the measuring plane and/or outside the measuring plane, by evaluating measurement data from transducer elements of at least one ultrasonic sensor array; and
correcting a localization error of the at least one determined distance between the ultrasonic sensor and the reflection position along the measuring plane using the determined angle.

15. The method according to claim 14, wherein an azimuth angle within the measuring plane and/or an elevation angle outside the measuring plane are determined as the at least one angle by the ultrasonic sensor array.

16. The method according to claim 14, wherein at least two distances are determined by at least two ultrasonic sensors and/or by one ultrasonic sensor and at least one ultrasonic sensor array along a measuring plane, based on the time-of-flight measurement of the sound waves, wherein a localization of reflection positions is performed using trilateration, wherein the localization error of the at least one determined distance between an ultrasonic sensor and a reflection position before trilateration or after trilateration is corrected using the determined angle.

17. The method according to claim 16, wherein a check is carried out as to whether the at least two distances determined within the measuring plane were determined by reflection from a common object or from a plurality of different objects.

18. The method according to claim 14, wherein the localization error of the at least one determined distance is corrected using the determined angle to a predefined height of the measuring plane above ground.

19. The method according to claim 18, wherein the localization error of the at least one determined distance is corrected using the determined angle to a height corresponding to a lowest installation position of an ultrasonic sensor of the sensor arrangement above the ground.

20. The method according to one of claim 14, wherein at least one reflection position determined by trilateration and/or at least one reflection position determined by individual measurements are assigned to at least one existing or one new object.

21. The method according to claim 15, wherein the angle determined as the azimuth angle within the measuring plane is used to resolve at least one ambiguity in an assignment of reflection positions to objects.

22. A sensor arrangement, comprising:
a control device;
at least one ultrasonic sensor; and
at least one ultrasonic sensor array having at least two transducer elements, wherein the ultrasonic sensor and the transducer elements of the ultrasonic sensor array are connected in a data-conducting manner to the control device, wherein the at least one ultrasonic sensor and the at least one ultrasonic sensor array have the same and/or a different installation height on a contour of a vehicle;
wherein the sensor arrangement is configured to correct at least one ultrasound-based measurement of the ultrasonic sensor of the sensor arrangement using the control device, sensor arrangement configured to:
transmit and/or receive sound waves by the at least one ultrasonic sensor, and determine at least one distance to a reflection position along a measuring plane based on a time-of-flight measurement of the sound waves;
determine at least one angle within the measuring plane and/or outside the measuring plane, by evaluating measurement data from the transducer elements of the at least one ultrasonic sensor array; and
correct a localization error of the at least one determined distance between the ultrasonic sensor and the reflection position along the measuring plane using the determined angle.

23. A method for resolving ambiguities of at least one ultrasound-based measurement of a sensor arrangement by a control device, the method comprising the following steps:
transmitting and/or receiving sound waves by at least one ultrasonic sensor and by at least one ultrasonic sensor array, wherein at least two distances to different reflection positions are determined based on a time-of-flight measurement of the sound waves;
determining at least one angle between the ultrasonic sensor array and at least one reflection position by evaluating measurement data from transducer elements of the ultrasonic sensor array; and
assigning the reflection positions and/or the determined distances to at least one object using the at least one determined angle.

24. A control device configured to correct at least one ultrasound-based measurement of an ultrasonic sensor of a sensor arrangement, the control device configured to:
transmit and/or receive sound waves by at least one ultrasonic sensor, and determine at least one distance to a reflection position along a measuring plane based on a time-of-flight measurement of the sound waves;
determine at least one angle within the measuring plane and/or outside the measuring plane, by evaluating measurement data from transducer elements of at least one ultrasonic sensor array; and
correct a localization error of the at least one determined distance between the ultrasonic sensor and the reflection position along the measuring plane using the determined angle.

25. A non-transitory machine-readable storage medium on which is stored a computer program for correcting at least one ultrasound-based measurement of an ultrasonic sensor of a sensor arrangement, the computer program, when executed by a computer, causing the computer to perform the following steps:
transmitting and/or receiving sound waves by at least one ultrasonic sensor, and determining at least one distance to a reflection position along a measuring plane based on a time-of-flight measurement of the sound waves;
determining at least one angle within the measuring plane and/or outside the measuring plane, by evaluating measurement data from transducer elements of at least one ultrasonic sensor array; and
correcting a localization error of the at least one determined distance between the ultrasonic sensor and the reflection position along the measuring plane using the determined angle.
